(19) United States
(12) Patent Application Publication
(10) Pub. No.: US 2024/0278935 A1
(43) Pub. Date: Aug. 22, 2024

(54) EXTREME THERMAL-FIT INSTALLATION FIXTURE

(71) Applicant: Textron Innovations Inc., Providence, RI (US)

(72) Inventor: Gregory Alan Spruce, Grand Prairie, TX (US)

(73) Assignee: Textron Innovations Inc., Providence, RI (US)

(21) Appl. No.: 18/172,837

(22) Filed: Feb. 22, 2023

(51) Int. Cl. B64F 5/10; F16C 35/06; F16C 43/04

(52) U.S. Cl. CPC B64F 5/10; F16C 35/06; F16C 43/04; B64C 29/0033

(57) ABSTRACT

A fixture for installing a bearing race around a mast at a particular location is described. The fixture includes a plurality of vertical rails; a mast retention assembly positioned in between the plurality of rails and connected to inner surfaces of the rails, the mast retention assembly including a mast retention opening for receiving the mast therethrough, the mast retention assembly maintaining the mast in a vertical orientation when the mast is disposed through the mast retention opening; and a shuttle translatably connected to inner surfaces of the rails, the shuttle configured to retain the bearing race in a bearing race retention opening of the shuttle and to translate the bearing race from an upper end of the mast as the mast is disposed through the mast retention opening, wherein the mast passes through an inner opening of the bearing race, and to the particular position on the mast.

### STATEMENT REGARDING FEDERALLY SPONSORED RESEARCH OR DEVELOPMENT

This invention was made with U.S. Government support under Agreement No. W9124P-19-9-0001 awarded by the Army Contracting Command-Redstone Arsenal to the AMTC and a related AMTC Project Agreement 19-08-006 with Bell Textron Inc. The Government has certain rights in the invention.

### TECHNICAL FIELD

This disclosure relates in general to the field of aircraft and, more particularly, though not exclusively, to a fixture for performing extreme thermal fit installation of a non-integral bearing raceway on a rotor mast.

### BACKGROUND

A non-integral bearing raceway on rotor masts of certain aircraft may require placement at the position of maximum bending, which drives design away from typical retaining features such as shoulders, threaded nuts, etc., due to their introduction of stress risers. As a result, a very high fit pressure is desirable to maintain absolute positioning of the bearing raceway through the lifetime of the mast.

Such a tight thermal installation may be complicated by the fact that high bearing raceway temperatures are required to obtain sufficient clearance during installation. Safety concerns and an extremely low margin of error for alignment preclude use of a conventional fully manual thermal installation process. Moreover, a press fit is undesirable as possibly causing damage to the mast and journal.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIG. 1A illustrates a perspective view of a tiltrotor aircraft in helicopter mode, according to one example embodiment;

FIG. 1B illustrates a perspective view of a tiltrotor aircraft in airplane mode, according to one example embodiment;

FIG. 2 illustrates an environmental view of an installation fixture according to one example embodiment;

FIG. 3 illustrates a perspective view of the installation fixture of FIG. 2 according to one example embodiment;

FIGS. 4-7 illustrate more detailed views of various features of the installation fixture of FIG. 2 according to one example embodiment;

FIGS. 8A-8C illustrate a closed-loop actuated cold block for an installation fixture according to one example embodiment; and

FIG. 9 is a flowchart illustrating a process of using the installation fixture of FIG. 2 according to one example embodiment.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this Specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of an aircraft relative to another component or component aspect(s). The term “aft” may refer to a spatial direction that is closer to a rear of an aircraft relative to another component or component aspect(s). The term “inboard” may refer to a location of a component that is within the fuselage of an aircraft and/or a spatial direction that is closer to or along a centerline of the aircraft (wherein the centerline runs between the front and the rear of the aircraft) or other point of reference relative to another component or component aspect. The term “outboard” may refer to a location of a component that is outside the fuselage of an aircraft and/or a spatial direction that farther from the centerline of the aircraft or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying FIGURES.

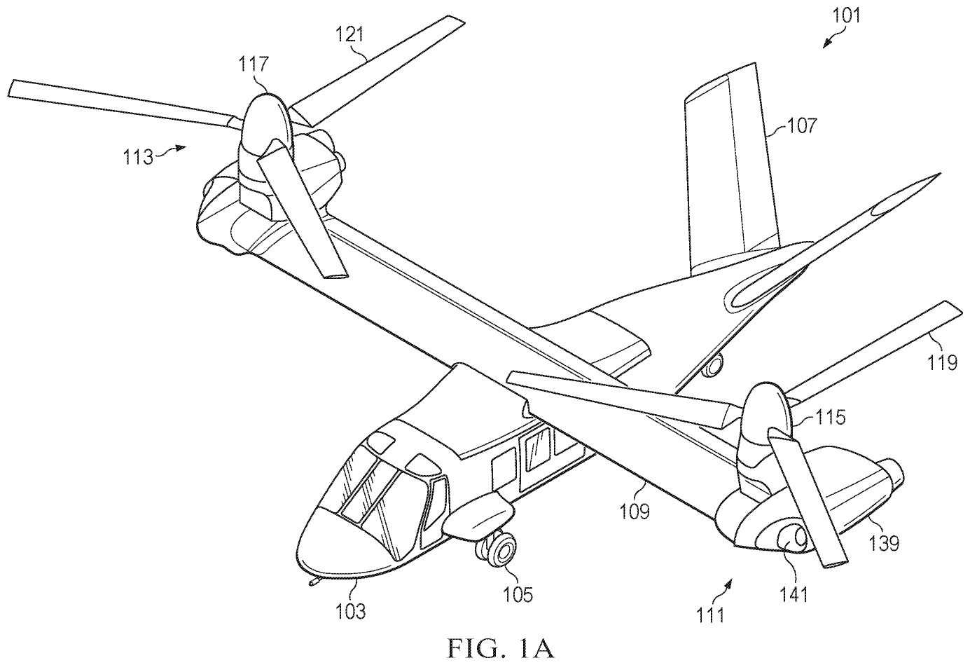

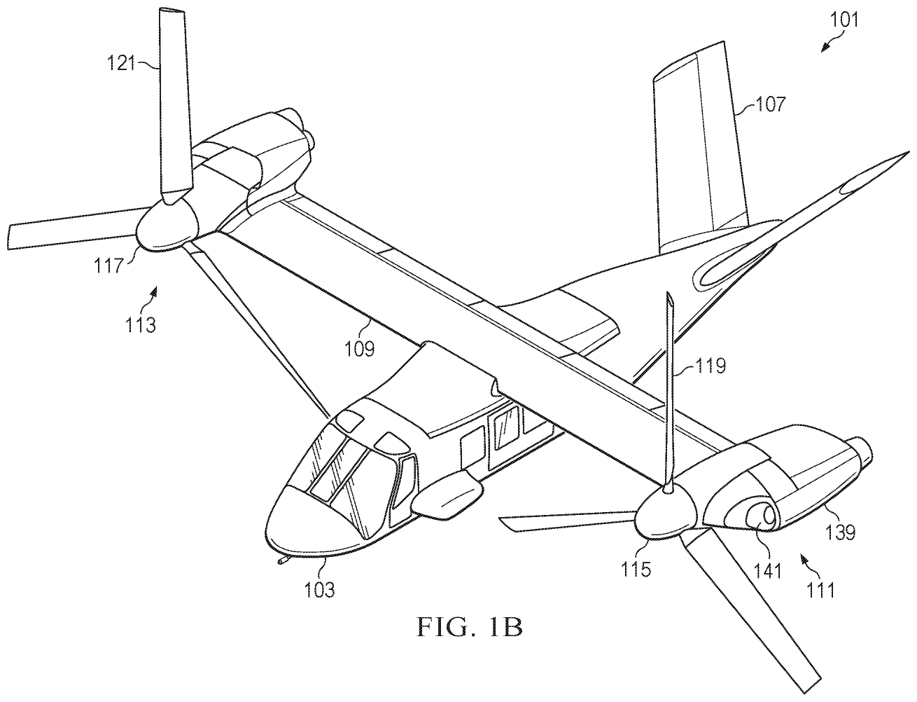

FIGS. 1A and 1B in the drawings illustrate a tiltrotor aircraft 101, according to one example embodiment. Tiltrotor aircraft 101 can include a fuselage 103, a landing gear 105, a tail member 107, a wing 109, a drive system 111, and a drive system 113. Each drive system 111 and 113 includes an engine and/or motor (e.g., engine 139) and a rotatable proprotor 115 and 117, respectively. Each rotatable proprotor 115 and 117 have a plurality of rotor blades 119 and 121, respectively, associated therewith. Rotor blades 119, 121, are connected to respective rotor masts (not shown in FIGS. 1A and 1B) to which rotational energy is applied by respective engines or motors. It will be recognized that each drive system 111, 113, may include appropriate gear boxes for transferring energy between the engine/motor and the rotor mast. The position of proprotors 115 and 117, as well as the pitch of rotor blades 119 and 121, can be selectively controlled in order to selectively control direction, thrust, and lift of tiltrotor aircraft 101.

FIG. 1A illustrates tiltrotor aircraft 101 in helicopter mode, in which proprotors 115 and 117 are positioned substantially vertically to provide a lifting thrust. FIG. 1B illustrates tiltrotor aircraft 101 in an airplane mode in which proprotors 115 and 117 are positioned substantially horizontally to provide a forward thrust in which a lifting force is supplied by wing 109. It should be appreciated that tiltrotor aircraft can be operated such that proprotors 115 and 117 are selectively positioned between airplane mode and helicopter mode, which can be referred to as a conversion mode.

The drive system 113 is substantially symmetrical to the drive system 111; therefore, for sake of efficiency, certain features will be disclosed only with regard to drive system 111. However, one of ordinary skill in the art would fully appreciate an understanding of drive system 113 based upon the disclosure herein of drive system 111.

Further, drive systems 111 and 113 are illustrated in the context of tiltrotor aircraft 101; however, drive systems 111 and 113 can be implemented on other tiltrotor aircraft. For example, an alternative embodiment may include a quad tiltrotor that has an additional wing member aft of wing 109; the additional wing member can have additional drive systems similar to drive systems 111 and 113. In another embodiment, drive systems 111 and 113 can be used with an unmanned version of tiltrotor aircraft 101. Further, drive systems 111 and 113 can be integrated into a variety of aircraft configurations. Additionally, other drive systems are contemplated. For example, one example is a gearbox arrangement to provide torque to a rotor system of a helicopter.

Embodiments described herein include a process and fixture for enabling high precision and high accuracy thermal installation of a bearing race on a rotor mast. Embodiments are particular useful for long shafts and/or masts but may be used in connection with any length shaft and/or mast. The process and fixture may be manual controlled or fully automated.

Certain aircraft masts include a non-integral bearing raceway that requires placement at the position of maximum bending. As a result, typical retaining features such as shoulders, threaded nuts, etc., are avoided due to their introduction of stress risers. Instead, a very high fit pressure is preferred to maintain absolute position of the bearing raceway throughout the mast lifetime. Such a tight thermal installation process may be complicated by the high bearing raceway temperatures required to obtain sufficient clearance during installation. Safety concerns and the extremely low tolerance for misalignment preclude typical fully-manual thermal install procedures. Moreover, a press-fit installation is not desirable due to the need to avoid damage to the mast and journal.

In accordance with features of embodiments described herein, an installation fixture allows for high precision and high accuracy thermal installation of a bearing race on a mast or shaft. In certain embodiments, the fixture is manually controlled. In alternative embodiments, the fixture is fully automated.

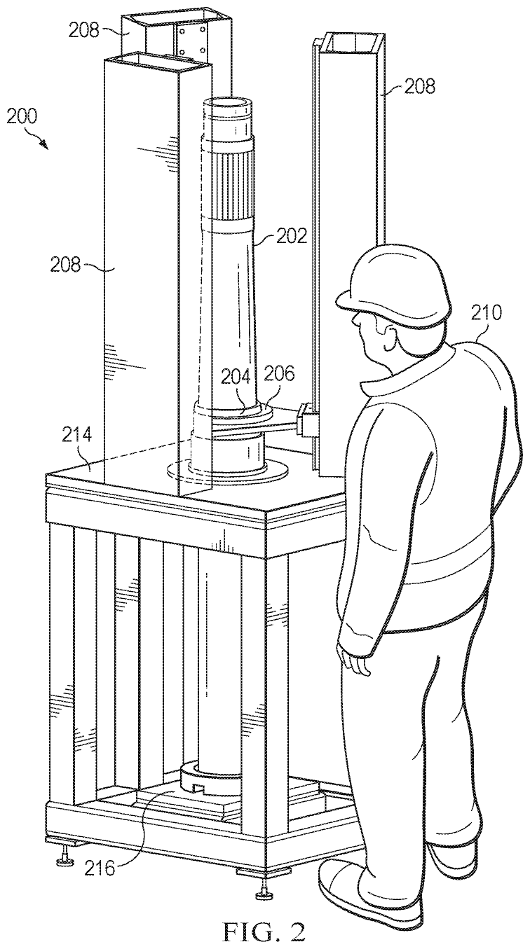

FIG. 2 illustrates an environmental view of an installation fixture 200 according to one example embodiment. As shown in FIG. 2, a mast 202 is retained within the fixture 200. A bearing race 204 to be installed on the mast 202 is supported on a shuttle 206, which is connected to a number of rails 208 such that the shuttle is translatable along the rails. In the illustrated embodiment, three rails are deployed, although more or fewer rails could be included. In particular embodiments, the rails are constructed from high pre-load steel. During installation, the shuttle 206 supporting the bearing race 204 is lowered along the rails 208 to a location on the mast 202 where the bearing race is to be installed. Positioning of the bearing race 204 on the mast 202 using the shuttle 206 may be performed by an operator 210. Alternatively, positioning of the bearing race 204 on the mast 202 using the shuttle 206 may be completely automated (e.g., using an actuator such as a belt and motor or rack and pinion, for example, with machine control programming), in which case, operator 210 may simply supervise the operation or may be omitted from the process. As will be described in greater detail herein below, in particular embodiments, mast 202 is disposed through an opening in a first horizontal platform 214 and supported at its base by a second horizontal platform 216 below the first horizontal platform 214.

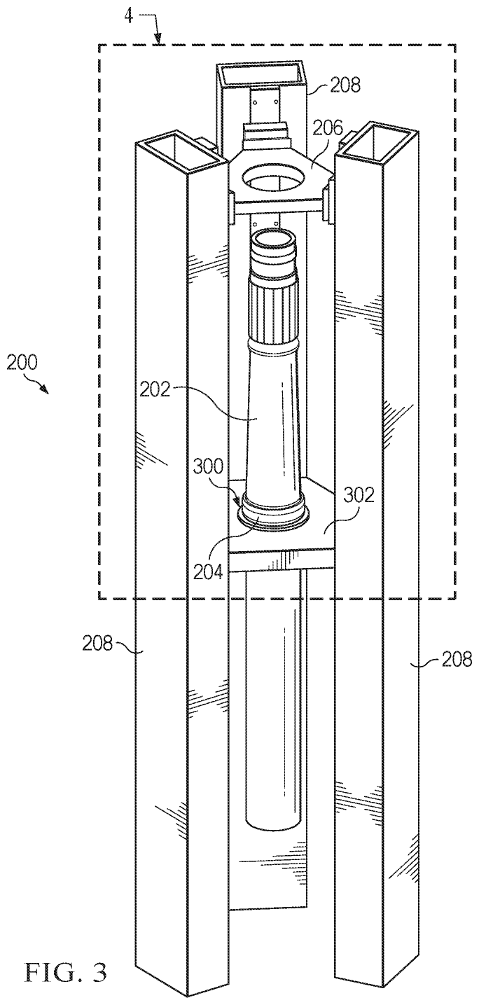

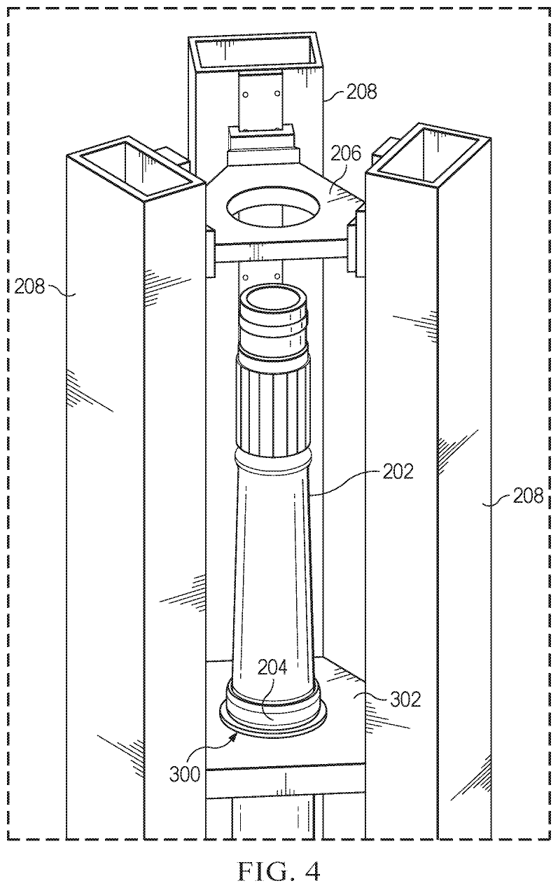

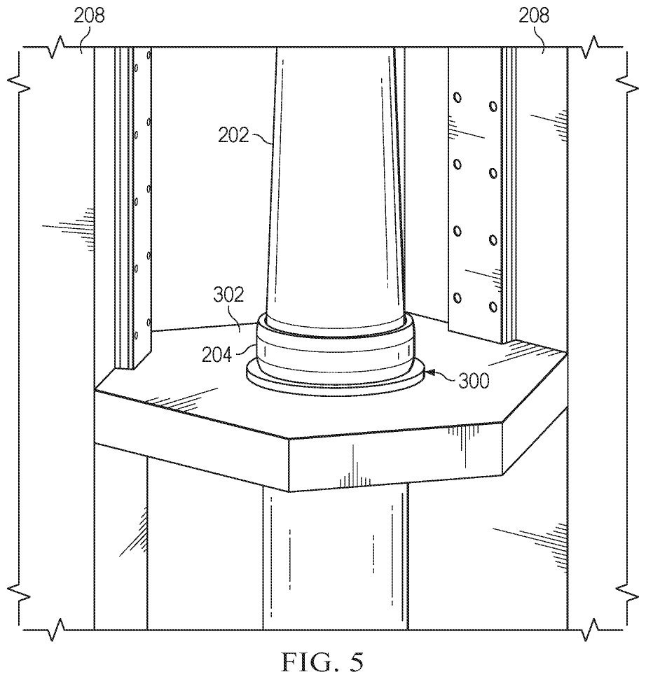

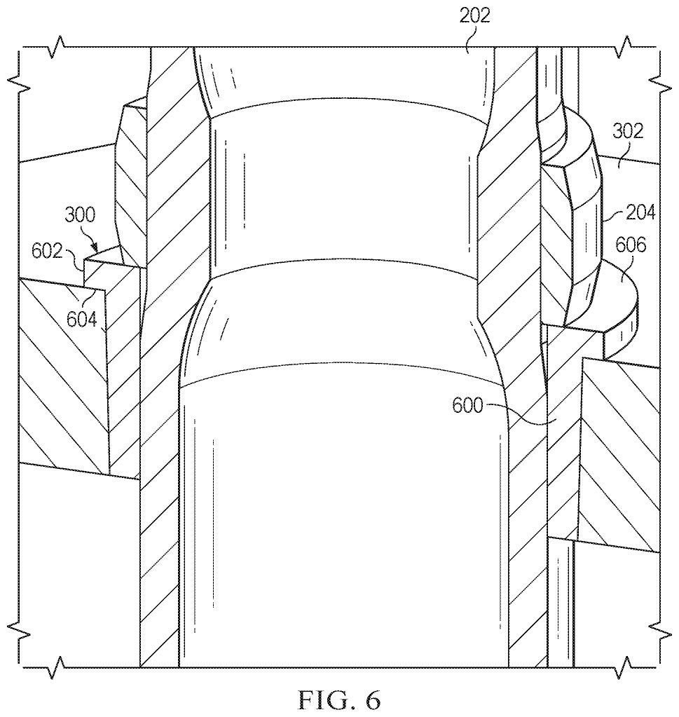

FIG. 3-7 illustrate various views and details of the installation fixture 200. In operation, after the mast 202 is lowered into the fixture 200, one or more modular cone stops 300 (best shown in FIG. 6) are positioned between the mast 202 and a mast retention plate 302. The cone stops 300 secure the mast 202 in an upright position in the fixture 200 and position the shuttle 206 and bearing race 204 along the length of the mast 202 so that the bearing race is installed in the correct location on the mast. As shown in FIG. 6, when the bearing race 204 is in position, it is supported by cone stops 300. In particular embodiments, two cone stops 300 are used; however, a different number of cone stops may also be advantageously deployed depending on the implementation. As best shown in FIG. 6, each of the cone stops 300 includes a vertical portion 600, which extends into an opening through the mast retention plate 302 between the plate and the external surface of the mast 202, and a horizontal portion 602 having a bottom surface 604 that rests on a top surface of the mast retention plate and a top surface 606 that supports the bearing race 204 when it is in proper position.

Once the mast 202 is positioned securely within the fixture 200, the bearing race 204 is heated and transferred to the shuttle 206. Alternatively, the bearing race 204 may be placed in the shuttle 206 and heated in situ, e.g., using an induction coil installed in the shuttle 206. In particular embodiments, the race should be heated as little as possible to obtain clearance (e.g., approximately 150 degrees Fahrenheit in some applications) up to limitations of the bearing steel (e.g., approximately 750 degrees Fahrenheit). In a particular embodiment, the race is heated to a minimum of approximately 400 degrees Fahrenheit.

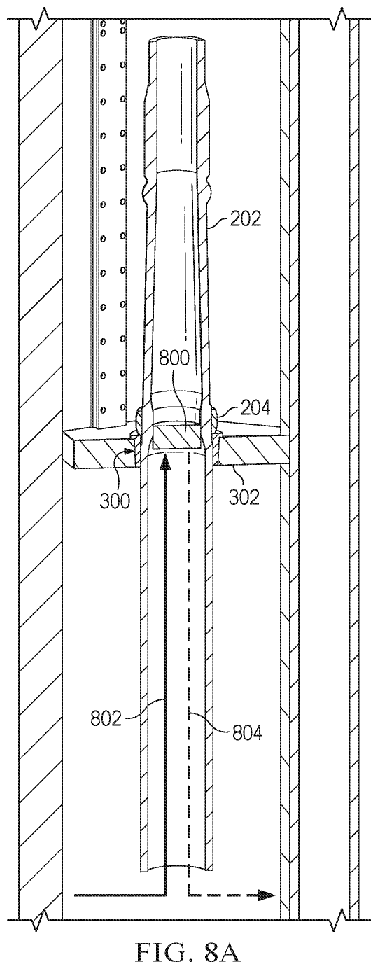

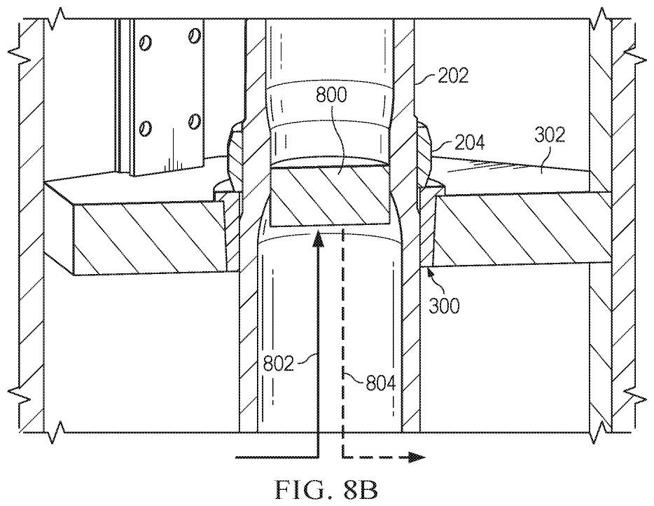

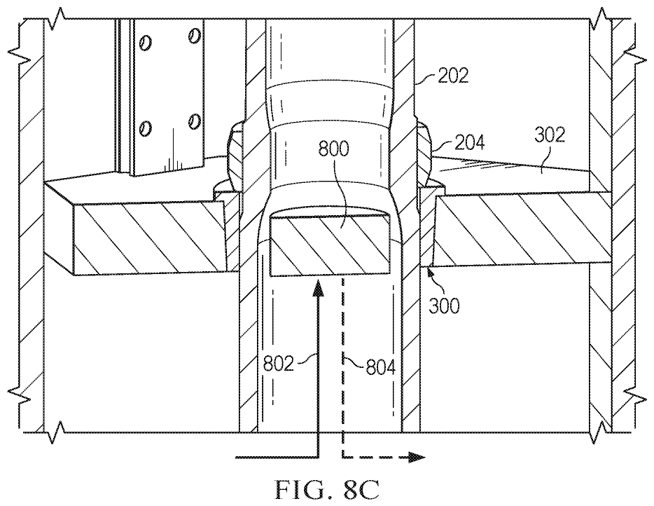

In certain embodiments, the mast 202 may be locally cooled prior to installation of the bearing race 204. For example, as shown in FIGS. 8A-8C, a closed-loop actuated cold block 800 may be used and prevent exposure to and waste of cryo-coolant. Condensation at the journal could be controlled via local high-pressure curtain of dehumidified air. As shown in FIG. 8A, coolant may be made to flow into the cold block 800 via a path 802 and may be expelled from the cold block via a path 804. Paths 802 and 804 combine with cold block 800 to implement a closed loop coolant systems. FIG. 8B illustrates the system after the cold block 800 has been actuated into a position inside the mast 202 in which it is in thermal contact with the position at which the bearing race 204 will be installed. FIG. 8C illustrates the system after the cold block 800 has been actuated into a position inside the mast 202 in which it is out of thermal contact with the position at which the bearing race 204 will be installed to minimize the spread of chilled mast area over time.

In particular applications, the cold block may be cooled to approximately the temperature of liquid nitrogen (e.g., −320 degrees Fahrenheit). It will be recognized that the minimum amount of cooling would be preferable to minimize the chances for condensation to occur. Control and positioning of the cooling block may be achieved using a computer numerical control (CNC) machine movement system, much like the shuttle movement above. Preferably, the cooled area would be as small (i.e., short in length) as possible and positioned directly underneath/inside the mast at the location of the journal on the outer diameter.

Once the heated bearing race 204 is secured within the shuttle 206, the shuttle is lowered into the final position along the mast 202; i.e., until the bearing race rests on and is supported by the cone stops 300, as best shown in FIG. 6. The bearing race 204 contracts as it cools and the mast 202 expands in response to the heat of the bearing race 204 until the two reach thermal equilibrium and a tight fit between the inside surface area of the bearing race 204 and the outside surface area of the mast 202 is attained.

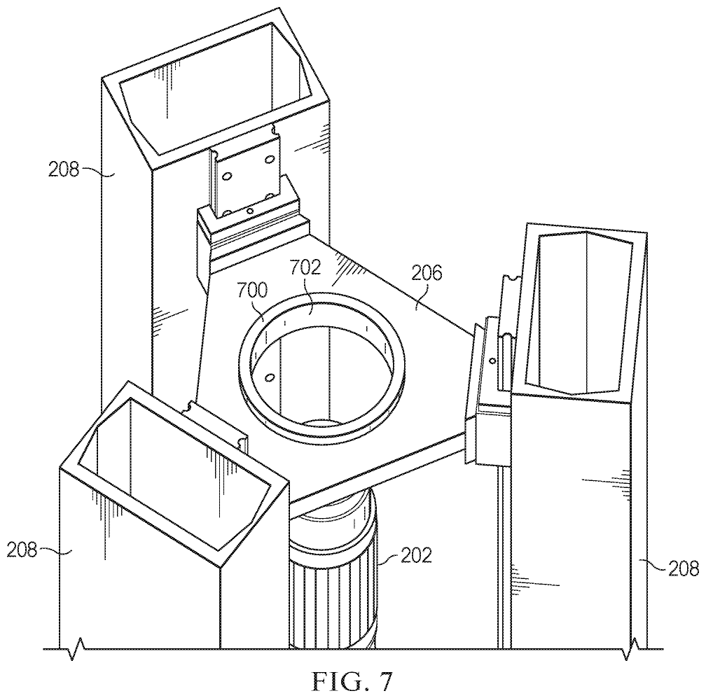

Referring particularly to FIG. 7, illustrated therein are additional details of the shuttle 206. In particular embodiments, the shuttle 206 may be kinematically mounted to rails 208 via rail blocks and an insert 700 restrains the bearing race 204 within an opening 702 of the shuttle 206 as the shuttle is lowered over the mast 202. In some embodiments, the insert 700 could be insulated to retain the heat of the bearing race 204 or could include a mass of metal that is heated with the bearing race to provide extra thermal heat. A heat battery could also be included to extend workable time to transfer the heated bearing race 204 to the shuttle 206. In other embodiments, the insert 700 could include an induction coil to heat the bearing race 204 or to maintain the heat of the heated bearing race 204 after it is heated (e.g., in a furnace). In particular embodiments, the insert may comprise two or more interconnecting portions such that the insert 700 may be removed while the mast remains in place for purposes described in detail below.

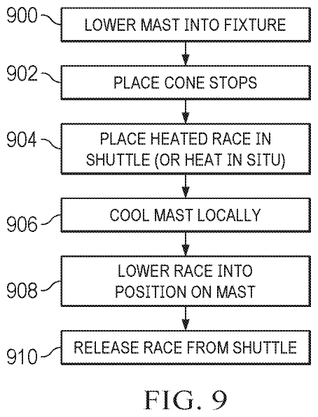

FIG. 9 is a flowchart of a process for installing a bearing race (e.g., bearing race 204) on a mast (e.g., mast 202) using installation fixture 200. As shown in FIG. 9, in step 900, the mast is lowered into the fixture. In step 902, modular cone stops are put in place to secure the mast and to position the bearing race along the mast. In step 904, the bearing race is heated and transferred to the shuttle of the fixture. Alternatively, the bearing race can be heated in situ using an induction coil in the shuttle.

In particular embodiments, the race can be held in the shuttle by a positive retention mechanism, such as an upper shuttle portion that is clamped around the race. Alternatively, the race may simply be situated in the conical shuttle seat and retained by gravity, thereby allowing for a self-centering and self-righting/aligning effect. To release the raceway, the shuttle can be moved past the installation location such that the insert, comprising two or more pieces, can be removed and the mast can be lifted out of the fixture.

In step 906, the mast may be locally cooled if desired. Such cooling may be performed using a closed loop actuated cold block, which prevents exposure to and waste of cryo-coolant. Condensation at the journal during cooling could be controlled via a local high-pressure curtain of dehumidified air. In step 908, the bearing race is lowered into the final position along the mast. At that point, the bearing race expands and the mast contracts as they reach thermal equilibrium. In step 910, once the bearing race is in the correct location, the bearing race is released from the shuttle as described above.

Embodiments described herein provide a relatively simple and inexpensive process for installation of a bearing race on a mast that is repeatable and precise with reduced touch-time. The process and fixture uses a minimal number of parts with high precision requirements and can be implemented using off-the-shelf motion components. The process is also fully automatable and possible for up to complete integration of heating and cooling plus integrated condensation prevention. The process and fixture also provide increased safety, reduced waste, and reduced risk of handling damage, due to partial and/or full automation. The modular design of the fixture ensures that it can accommodate different aircraft masts and the vertical design thereof minimizes the amount of floor space required to implement.

Embodiments described herein enable precise installation of a bearing race on a mast (especially along one) with reduced touch time in a relatively simple and inexpensive manner. Embodiments further utilize minimal parts with high precision requirements and may be implemented using off-the-shelf motion components. Moreover, embodiments are fully-automatable, enable up to full integration of heating and cooling plus integrated condensation prevention, increase safety, reduce waste, and reduce risk of handling damage. Its modular design can accommodate differently sized masts, the vertical design minimizes floor space required, and it enables high-rate, low-scrap, low-re-work production.

Example 1 provides a fixture for facilitating installation of a bearing race around a mast at a particular location along a length of the mast, the fixture including a plurality of rails oriented vertically; a mast retention assembly positioned in between the plurality of rails and connected to inner surfaces of the plurality of rails, the mast retention assembly including a mast retention opening for receiving the mast therethrough, the mast retention assembly maintaining the mast in a vertical orientation when the mast is disposed through the mast retention opening; and a shuttle translatably connected to inner surfaces of the rails, the shuttle configured to retain the bearing race in a bearing race retention opening of the shuttle and to translate the bearing race from an upper end of the mast as the mast is disposed through the mast retention opening, wherein the mast passes through an inner opening of the bearing race, and to the particular location along the length of the mast.

Example 2 provides the fixture of example 1, wherein the rails include steel.

Example 3 provides the fixture of example 1, wherein the mast retention assembly includes a mast retention plate having the mast retention opening therethrough.

Example 4 provides the fixture of example 3, wherein the mast retention assembly further includes at least one modular cone stop.

Example 5 provides the fixture of example 4, wherein the at least one cone stop includes a vertical portion that extends within the mast retention opening and a horizontal portion that abuts a top surface of the mast retention plate and upon which the bearing race rests.

Example 6 provides the fixture of example 1, further including a ring-shaped insert within the bearing race retention opening of the shuttle.

Example 7 provides the fixture of example 5, wherein the insert includes at least two interconnecting portions.

Example 8 provides the fixture of example 1, wherein the shuttle further includes an induction coil for heating the bearing race.

Example 9 provides the fixture of example 1, wherein the bearing race is heated before being retained in the shuttle.

Example 10 provides the fixture of example 1, wherein the bearing race is heated in situ after being retained in the shuttle.

Example 11 provides the fixture of example 1, wherein the particular location along the length of the mast is cooled prior to translation of the bearing race to the particular location along the length of the mast.

Example 12 provides the fixture of example 11, further including a cooling assembly for locally cooling the particular location along the length of the mast.

Example 13 provides a method of installing a bearing race on a mast using an installation fixture, the installation fixture including a shuttle for retaining the bearing race during installation, the shuttle translatably connected to a plurality of rails, the method including securing the mast in the fixture; heating the bearing race; securing the bearing race in the shuttle; lowering the shuttle and bearing race around the mast to a predetermined location on the mast; and allowing the bearing race and the mast to reach thermal equilibrium to secure the bearing race to the mast at the predetermined location.

Example 14 provides the method of example 13, wherein the heating the bearing race is performed prior to the securing the bearing race.

Example 15 provides the method of example 13, wherein the heating of the bearing race is performed subsequent to the securing the bearing race.

Example 16 provides the method of example 13, further including cooling an area of the mast proximate the predetermined location prior to the lowering.

Example 17 provides the method of example 13, further including, subsequent to the allowing, releasing the bearing race from the shuttle.

Example 18 provides the method of example 13, further including lowering the mast into the fixture such that the mast passes through an opening in a mast retention plate, the securing further including providing at least one modular cone stop between the opening in the mast retention plate and an external surface of the mast.

Example 19 provides a fixture for facilitating installation of a bearing race around a hollow shaft including a mast at a particular position on the mast, the fixture including a base; a plurality of rails extending vertically from a top surface of the base; a mast retention assembly positioned in between the plurality of rails and connected to inner surfaces of the plurality of rails, the mast retention assembly including a mast retention opening for receiving the mast therethrough, the mast retention assembly maintaining the mast in a vertical orientation when the mast is disposed through the mast retention opening; a shuttle translatably connected to inner surfaces of the rails, the shuttle configured to retain the bearing race in a bearing race retention opening of the shuttle and to translate the bearing race from an upper end of the mast as the mast is disposed through the mast retention opening, wherein the mast passes through an inner opening of the bearing race, and to the particular position on the mast; and a cooling assembly including a cooling block disposed within the hollow shaft including the mast, wherein a fluid including a coolant is introduced into the cooling block via a first fluid path and wherein the fluid including the coolant is expelled from the cooling block via a second fluid path.

Example 20 provides the fixture of example 19, wherein the coolant block is actuatable between a first position which substantially corresponds to the particular position on the mast and a second position lower than the particular positon on the mast, and wherein the shuttle is configured to heat the bearing race in situ.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rl, and an upper limit, Ru, is disclosed, any number falling within the range is specifically disclosed. In particular, the following numbers within the range are specifically disclosed: R=Rl+k*(Ru−Rl), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this Specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

1. A fixture for facilitating installation of a bearing race around a mast at a particular location along a length of the mast, the fixture comprising:
a plurality of rails oriented vertically;
a mast retention assembly positioned in between the plurality of rails and connected to inner surfaces of the plurality of rails, the mast retention assembly including a mast retention opening for receiving the mast therethrough, the mast retention assembly configured to maintain the mast in a vertical orientation when the mast is disposed through the mast retention opening; and
a shuttle translatably connected to the inner surfaces of the plurality of rails, the shuttle comprising a retention opening for retaining the bearing race therein, the shuttle translating the bearing race retained in the retention opening from an end of the mast to the particular location along the length of the mast while the mast is disposed through the mast retention opening, wherein the mast remains stationary within the mast retention assembly while the bearing race is translated by the shuttle.

2. (canceled)

3. The fixture of claim 1, wherein the mast retention assembly comprises a mast retention plate having the mast retention opening therethrough.

4. (canceled)

5. The fixture of claim 3, wherein the mast retention assembly further comprises at least one modular cone stop and wherein the at least one modular cone stop comprises a vertical portion that extends within the mast retention opening and a horizontal portion that abuts a top surface of the mast retention plate and upon which the bearing race is capable of resting.

6. The fixture of claim 1, further comprising a ring-shaped insert within the bearing race retention opening of the shuttle.

7. The fixture of claim 6, wherein the insert comprises at least two interconnecting portions.

8. The fixture of claim 1, wherein the shuttle further comprises an induction coil for heating the bearing race.

9. The fixture of claim 1, wherein the bearing race is heated before being retained in the shuttle.

10. The fixture of claim 1, further comprising a heating element for heating the bearing race in situ while the bearing race is retained in the shuttle at the particular location along the length of the mast.

11. The fixture of claim 1, further comprising a cooling element for cooling the particular location along the length of the mast before the bearing race is translated to the particular location along the length of the mast.

12. (canceled)

13. A method of installing a bearing race on a mast using an installation fixture, the installation fixture including a shuttle for retaining the bearing race during installation, the shuttle translatably connected to a plurality of rails, the method comprising:
securing the mast in the fixture;
heating the bearing race;
securing the bearing race in the shuttle;
lowering the shuttle and bearing race around the mast to a predetermined location on the mast; and
allowing the bearing race and the mast to reach thermal equilibrium to secure the bearing race to the mast at the predetermined location.

14. The method of claim 13, wherein the heating the bearing race is performed prior to the securing the bearing race.

15. The method of claim 13, wherein the heating of the bearing race is performed subsequent to the securing the bearing race.

16. The method of claim 13, further comprising cooling an area of the mast proximate the predetermined location prior to the lowering.

17. The method of claim 13, further comprising, subsequent to the allowing, releasing the bearing race from the shuttle.

18. The method of claim 13, further comprising lowering the mast into the fixture such that the mast passes through an opening in a mast retention plate, the securing further comprising providing at least one modular cone stop between the opening in the mast retention plate and an external surface of the mast.

19. A fixture for facilitating installation of a bearing race around a hollow shaft comprising a mast at a particular position on the mast, the fixture comprising:
a base;
a plurality of rails extending vertically from a top surface of the base;
a mast retention assembly positioned in between the plurality of rails and connected to inner surfaces of the plurality of rails, the mast retention assembly including a mast retention opening for receiving the mast therethrough, the mast retention assembly maintaining the mast in a vertical orientation when the mast is disposed through the mast retention opening;
a shuttle translatably connected to inner surfaces of the rails, the shuttle configured to retain the bearing race in a bearing race retention opening of the shuttle and to translate the bearing race from an upper end of the mast as the mast is disposed through the mast retention opening, wherein the mast passes through an inner opening of the bearing race, and to the particular position on the mast; and
a cooling assembly comprising a cooling block disposed within the hollow shaft comprising the mast, wherein a fluid comprising a coolant is introduced into the cooling block via a first fluid path and wherein the fluid comprising the coolant is expelled from the cooling block via a second fluid path.

20. The fixture of claim 19, wherein the coolant block is actuatable between a first position which substantially corresponds to the particular position on the mast and a second position lower than the particular positon on the mast, and wherein the shuttle is configured to heat the bearing race in situ.
